(19) United States
(12) Patent Application Publication
(10) Pub. No.: US 2009/0290848 A1
(43) Pub. Date: Nov. 26, 2009

(54) Method and System for Generating a Replay Video

(76) Inventor: Michael James Brown, West Vancouver (CA)

Correspondence Address: ADE & COMPANY INC., 2157 Henderson Highway, WINNIPEG, MB, R2G1P9, CA

(21) Appl. No.: 12/523,016

(22) PCT Filed: Jan. 10, 2008
(86) PCT No.: PCT/CA08/00062

§ 371 Date: Jul. 13, 2009

Related U.S. Application Data
(60) Provisional application No. 60/884,530, filed on Jan. 11, 2007.

(51) Int. Cl. H04N 5/222; H04N 5/91

(52) U.S. Cl. 386/52; 348/159; 386/E05.003; 348/E05.022

(57) ABSTRACT

A plurality of cameras are controlled to follow a common moving target in a three dimensional environment such that each camera generates a video feed comprising a plurality of video segments captured sequentially. Each video segment comprises a static image of the target at a respective point in time. A resulting video is generated by selecting a sequence of video segments which may include video segments from different cameras and at the same or different points in time to create various video effects. The recorded video segments are categorized for later recall according to camera identification and point in time to allow for instantaneous recall for producing video replays from a variety of camera angles during a live event. Auxiliary video segments can be computer generated for insertion between video segments captured by the cameras for smoothing the appearance of the resulting video.

### FIELD OF THE INVENTION

The present invention relates to a system and method of use thereof for producing a video assembled from video segments generated by a plurality of cameras at different camera angles for example. In a preferred embodiment, the invention is particularly suited for generating a replay video during a live sporting event in which the camera angle can be rotated at least partway about the target to be captured by switching between recorded video feeds from plural different cameras. The invention also relates to a system and method for controlling a plurality of cameras to follow the target to be captured on video.

### BACKGROUND

Systems and methods are known for recording video feeds from a plurality of different cameras at sporting events and the like. Typically in such a system, the multiple cameras are provided at different angles and the video from the cameras is fed to a control room where a production crew edits the different feeds to produce a single video feed broadcast to viewers. Known systems generally require video to be stored in clips each from a single respective camera feed for subsequent replay as later desired.

In some instances it is desired to review a replay or a continuous feed of video from varying points of view. Using conventional techniques however, a production crew is required to apply considerable time and expense into editing the video clips to produce such a resulting video with varied points of view.

Various attempts have been made to generate replay videos or video feeds from sporting events which are enhanced as compared to current conventional video editing techniques as described in the following prior art documents: U.S. Pat. No. 5,363,297 issued Nov. 8, 1994 (Larson et al); U.S. Pat. No. 5,598,208 issued Jan. 28, 1997 (McClintock); U.S. Pat. No. 5,600,368 issued Feb. 4, 1997 (Mathews); U.S. Pat. No. 6,124,862 issued Sep. 26, 2000 (Boyken et al); U.S. Pat. No. 6,631,522 issued Oct. 7, 2003 (Erdelyi); U.S. Pat. No. 7,012,637 issued Mar. 14, 2006 (Blume et al); U.S. Pat. No. 7,035,453 issued Apr. 25, 2006 (Liu); U.S. published application 2004/0032495 (Ortiz); US published application 2004/0263626 (Piccionelli).

None of the prior art systems noted above however allow video from a plurality of differently oriented cameras to be recalled in various combinations instantly in a manner which differs from the selected broadcast feed and thus the prior art attempts do not provide an adequate solution for providing instant replay videos from varied points of view in a live sporting event. Furthermore, none of the prior art noted above provides a plurality of cameras that can be readily operated by a single operator using available equipment in a low cost and efficient manner.

U.S. Pat. No. 6,933,966, to Taylor, discloses a system for producing time independent virtual camera movement in motion pictures. The preferred embodiment comprises a plurality of cameras of fixed orientation along a fixed path, each for capturing a simultaneous image of a common target object. The images are assembled into a sequence on a filmstrip so that a resulting video is produced in which a viewpoint is displaced along the fixed path about the object while the object remains static. The use of motion picture cameras is suggested in one embodiment of the invention, however no means are provided or suggested for capturing and storing the captured images in an efficient manner for instantaneous recall as would be required for replays during a live event and accordingly, Taylor does not address the problems of the prior art noted above. Furthermore, no means are provided or suggested in Taylor as to how a moving target might be captured by the motion picture cameras, as the array of cameras proposed by Taylor must all be fixed relative to one another.

### SUMMARY OF THE INVENTION

According to one aspect of the invention there is provided a method of producing a resulting video of an event in a target environment, the method comprising:

providing a plurality of cameras directed at a common target in the target environment;

generating a video feed from each camera comprising a sequence of video segments over time, in which each video segment comprises a static image in the sequence at a respective point in time;

associating segment data with each video segment, said segment data including time step data representing the point in time when the video segment was generated and camera identification data representing the camera from which the video segment is generated;

recording the video segments and the associated segment data onto a storage device;

categorizing the video segments on the storage device according to the associated segment data;

selecting a selected sequence of the video segments to be used in the resulting video to be generated;

recalling the selected sequence of the video segments from the storage device by identifying the segment data associated therewith; and

assembling the selected sequence of the video segments into the resulting video.

Preferably the method includes recording and categorizing the video segments in a realtime, instantaneous manner such that the selected sequence can be assembled into the resulting video instantaneously upon recordation of the video segments of the selected sequence. Accordingly when the selected sequence represents a portion of a live event, the video segments of the selected sequence can be assembled into the resulting video during the live event, for example for generating instant replays during a live sporting event. Preferably the cameras are reoriented to follow a moving target in the target environment during generation of the video segments.

By providing video feed comprised of video segments and storing each of the individual video segments in a categorized manner according to segment data associated with each video segment, a computer as controlled by an operator can readily recall any number of individual video segments in any desired order for assembly into a resulting video which can be instantly altered in rate, point of view, or a combination thereof. Categorizing individual video segments according to segment data associated therewith represents a low cost and efficient method of organizing video segments as they are produced for efficient recall in a manner which is advantageous over the prior art. The organized manner of recording the video segments with segment data associated therewith permits selected video segments to be recalled from the storage device and assembled into a video while video feed from a plurality of cameras are continuously being recorded to the same storage device from which previously recorded segments are being recalled.

According to a second aspect of the present invention there is provided a method of controlling a plurality of cameras to capture a target within a target environment, the method comprising:

positioning the plurality of cameras within the target environment;

arranging each camera to be movable in orientation to vary a direction of video capture of the camera in response to operational instructions;

identifying a location of each camera in relation to the target environment;

identifying location of the target in relation to the target environment;

calculating the operational instructions for each camera using the location of the camera and the location of the target relative to the target environment such that the operational instructions are arranged to orient the direction of video capture of the camera towards the target;

orienting each camera to capture video of the target using the operational instructions; and

recalculating the operational instructions for each camera each time the location of the target relative to the target environment changes to follow the target as the target is displaced within the target environment.

According to a third aspect of the present invention there is provided a method of producing a resulting video of an event in a target environment, the method comprising:

providing a plurality of cameras directed at a common target in the target environment;

generating a video feed from each camera comprising a sequence of video segments over time, in which each video segment comprises a static image in the sequence at a respective point in time;

recording the video segments onto a storage device;

selecting a selected sequence of the video segments to be used in the resulting video to be produced;

interpolating between an adjacent pair of video segments in the selected sequence to produce an auxiliary video segment; and

assembling the selected sequence of the video segments and the auxiliary video segment into the resulting video.

The auxiliary video segment may comprise a video segment which is generated by interpolating between selected video segments generated at sequential points in time. Alternatively, the auxiliary video segment comprises a video segment which is generated by interpolating between two video segments which are generated from an adjacent pair of the cameras. The auxiliary video segment may also be interpolated between video segments from different cameras and from different points in time.

The present invention is advantageous over prior art systems in that there is provided a method of categorizing the analog video so that the video can be retrieved by camera identification and time, in a synchronized and realtime manner. The system of the present invention has been designed with live production in mind as realtime playback is critical to operation in a production environment. Due to the method of categorizing images as described herein, the present invention isn't limited to generating the same video effect as in prior art system, but rather time can also move between adjacent images in a selected sequence in addition to the virtual camera movement by switching from which camera images are taken. Further the present invention provides a method of controlling the robotics of the cameras in a three dimensional manner so they can be targeted to objects in three dimensional space. The cameras have the ability to define the path of the images captured constantly throughout operation as they can target their focus using camera robotics. Yet further, the present invention provides a method of generating an output video based on the recorded video, and manipulating it to improve the quality and smoothness of the effect.

Preferably at least one pair of adjacent video segments of the selected sequence forming the resulting video comprises video segments which are generated from adjacent ones of the cameras and/or which are generated at a common point in time.

The camera identification data preferably includes camera position data and camera orientation data.

The video segments may be selected and assembled according to segment data criteria. The segment data criteria may comprise, for example, a sequence of varying time step data, a sequence of camera identification data; a sequence selected with common, fixed time step data; or a sequence of different cameras selected over changing time step data.

There may be provided a user interface comprising a graphical representation of the video segments categorized according to both time step data and camera identification data in which the segment data criteria can be selected graphically using the user interface. Alternatively, the segment data criteria may be automatically determined by an automated controller.

The selected sequence of the video segments may be assembled into the resulting video at a different time scale than the video feed from said at least one camera by varying the interval of time occupied by each video segment in the resulting video as compared to the interval of time between generation of video segments by the cameras. The time step data thus comprises an interval of time occupied by the associated video segment in the respective video feed.

When the time step data associated with each video segment comprises an interval of time occupied by the video segment, the method may thus include varying duration of the time step data of the selected portion of the video segments during assembly into the resulting video.

The cameras are preferably supported at spaced apart locations from one another along a fixed path such that orientation of the camera at each location can be controllably varied.

In one embodiment, the cameras are supported circumferentially about the target environment. Alternatively, the cameras may be supported in a circumferential pattern about each of two opposed ends of the target environment.

The method may include periodically checking operation of the cameras to determine if one of the cameras has failed and discontinuing capturing video segments from a camera which has failed. The method may further include generating auxiliary video segments for a camera which has failed in which the auxiliary video segments each comprise an image interpolated between video segments at a corresponding point in time from adjacent ones of the cameras.

Each camera is preferably oriented relative to adjacent ones of the cameras such that each video segment generated by each camera generally approximates an image interpolated between video segments generated by the adjacent ones of the cameras at the same point in time.

Prior to generating video feed for producing a resulting video, the location of each camera may be determined by focusing the cameras on a three dimensional target object and analyzing a two dimensional image captured by each camera to determine the relative position of the camera to the three dimensional target object.

The location of the target being captured by the cameras may be varied using a control device comprising a user controllable master camera having a video feed which defines the location of the target and calculating operational instructions for the plurality of cameras such that the plurality of cameras follow the location of the target defined by the master camera. The control device may include a controller comprising a movable display arranged for displaying the video feed from the master camera and a position encoding device arranged for displacing the master camera responsive to corresponding displacement of the moveable display.

Some embodiments of the invention will now be described in conjunction with the accompanying drawings in which:

### BRIEF DESCRIPTION OF THE DRAWINGS

FIG. 1 is a schematic view of a system which produces a replay video by recording video segments from a plurality of cameras and subsequently recalling selected video segments for assembly into a resulting replay video.

FIG. 2 is a schematic illustration of the system and method for recording video segments in the system of FIG. 1.

FIG. 3 is a schematic illustration of the process for recalling video segments for assembly into the resulting replay video according to the system of FIG. 1.

FIG. 4 is a schematic illustration of the video segment selection process from video segments catalogued on the storage device.

FIG. 5 is a schematic view of a process for controlling the plurality of cameras which generate the video feeds for the system of FIG. 1.

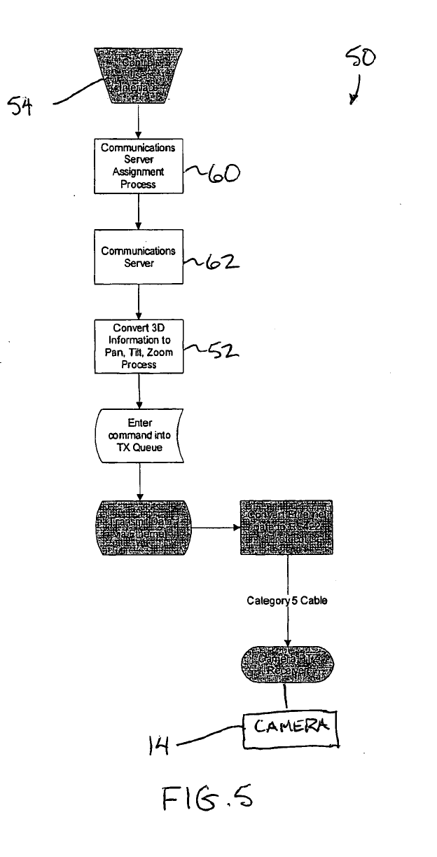

FIG. 6 is a schematic illustration of a controller used to operate the plurality of cameras in a typical system setup.

FIG. 7 is a schematic illustration of a monitor for the system of FIG. 1 for detecting potential system failures.

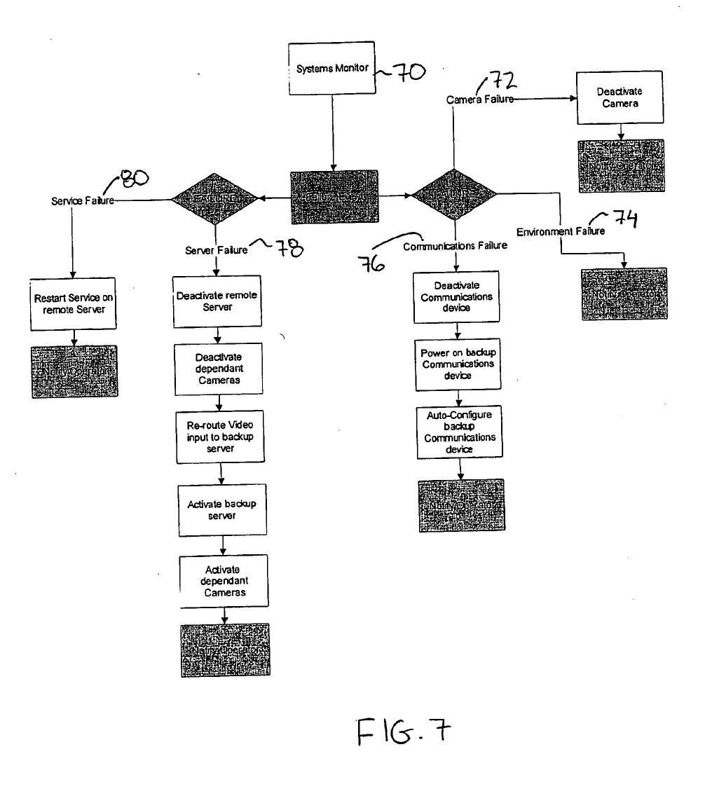

FIG. 8 is a schematic illustration of a typical positioning of the cameras within a target environment to be captured on video.

FIG. 9 is a schematic illustration of the positioning of the cameras according to one embodiment of the present system when positioned above a playing surface for a game of hockey.

FIG. 10 is a schematic illustration of a camera positioning according to a further embodiment when the target environment comprises a boxing ring.

FIG. 11 is a schematic illustration of a further embodiment of the camera positioning for use in an arena or stadium and the like.

In the drawings like characters of reference indicate corresponding parts in the different figures.

### DETAILED DESCRIPTION

Referring to the accompanying figures there is illustrated a replay video generating system 10 and associated method for producing a resulting video in which video frames or segments from the video feeds of one or more cameras can be instantly recalled in portions and in any selected order to be instantly assembled into a new replay video while continuing to record live ongoing video feed from the one or more cameras.

Referring further to the figures, there is also illustrated a system for controlling a plurality of cameras within a target environment from a single input of a target location upon which all of the cameras are subsequently focused.

The video generating system described herein is a camera processing and control system designed to generate unique “3D-like” effects based upon many video camera devices pointing at a central location. The system can create a resulting video effect that can spin around a subject, allowing the viewer to visibly see a subject from all 360 degrees, as well as stop time and motion. The system generates video files intended for computer playback, or instant playback for delivery to a television display.

The system is intended to be used for sports video replays in a near-realtime fashion. Alternate uses for the system may include sports training, post analysis of a sports event, and special effects destined for film/television.

The system is a combination of readily available hardware, and custom software to allow this hardware to communicate in ways never intended. Utilizing computers, cameras, communication hardware, the system uses software to convert, translate, and generate new video in order to display it in unique ways.

A camera capture and control system uses a simplified User Interface to allow an operator to track an event using a single view, capturing and passing off targeting information to a distributed network of servers responsible for recording video and targeting cameras. This system allows the user to initiate the distributed capture/encoding process remotely via a transparent process.

A Real Time Hardware Control System Software operates components to communicate with the User Interface's event-driven model and provide a separation between hardware communication and control requirements. Components translate 3-dimensional co-ordinates to real-world requirements that target the robotics sub-system of the cameras. Components also asynchronously poll device communications to monitor failures, status and performance.

Replays are developed using a system of automated and/or user operated interfaces that provide the catalogue description of how a video is to be generated. The video generation system described herein redefines the paradigm for the traditional non-linear video editing process by aligning the concept of time into different models for the source and output video. The system treats source video as a collection of video sources from an unlimited number of camera feeds, rather than a single video feed. New editing concepts were developed to easily explain the relationship of time in 2 dimensions.

Optional software components allow the configuration of physical camera locations using surveying data, or automatic configuration by using image processing algorithms.

Systems and procedures are also present that allow the system to detect, fix, or remove problem hardware when necessary.

A distributed computing model was chosen to allow the processing of complex and dynamic information involved in the digitizing of a mass number of analog video sources and the physical control of a large number of robotic mechanisms to position cameras.

In addition communication protocols have been developed for components not originally suited for this type of work.

Furthermore a monitoring system has been developed for monitoring the large number of physical devices that can be prone to failure for environmental reasons.

Cross-Camera Interpolation Analysis Software has been used to overcome limitations in available routines that assume frames of video destined for interpolation are coming from the same source and for creating “in-between” frames from multiple sources of video to create frames that appear as though they come from cameras that do not physically exist.

The video generation system described herein is normally configured in a circular ring, allowing cameras to capture video from all 360 degrees about a target. Multiple rings may be configured to cover a larger area while still providing a detailed picture. Generally the rail is constructed of aluminium truss, configured in a dodecagon (12-sided polygon) shape, however other polygon shapes can be used depending on the size of the ring required, Cameras are attached to the aluminium rail at equal spacing (usually 7-12 degrees).

Optionally, the cameras can be attached to existing building structures if an overhanging railing should prove difficult or obtrusive. The cameras can be mounted at different heights and distances from the subject however the desired effect may be reduced.

The ring is connected to the processing system via standard Category 5 Ethernet cable, or optionally for longer distances fiber optic cable can be used. The cabling connects video, and data communication with each camera to the processing system. Additionally, power can be run from the processing system over a long distance to each camera at 48 volts DC, and then converted to the appropriate voltage level for each camera.

Once connected to the cameras, the processing system has complete control over data communication with each camera, and can begin digitizing and converting the video into a meaningful format understood by the processing system.

The video generation system is separated into 3 key systems: Video Acquisition, Camera Control, and Video Processing.

Video Acquisition

The system is designed to capture video from an unlimited number of sources. Normally the system will acquire video from 36-72 video cameras, in 1 or 2 separate rings covering 36 video cameras each. The actual number of cameras may change depending on the size of the event area. The 2 separate rings are required in larger events to allow the system to capture video from a wider spanned area such as a hockey rink, while minimizing the use of optical zoom on each camera, therefore increasing detail.

The video is transmitted from the camera over Category 5 twisted pair cable, which is made possible by the use of special impedance matching transformers to convert the signal from 75 ohm to approximately 120 ohm, giving the ability to transmit the video over a great distance on inexpensive Category 5 cable. Fiber optic transmission can be used when the camera distance is over 2000-3000 ft. from the processing system, otherwise Category 5 cable is preferred to decrease the cost of the system.

The video arrives at the system in analog format, and needs to be converted back to 75 ohm impedance before it is inserted into the capture system. The capture system consists of a Server, and a video digitizing card capable of converting 4 analog video streams at once, at full resolution of 640×480 pixels at a frame rate of 30 frames per second. The video digitizing system then stores each individual frame of video as 2 separate fields in an in-memory buffer, and when the in-memory buffer is full it then writes the data to a permanent storage device such as a hard drive. The in-memory buffer is required as most commercially available hard drives cannot store that amount of data quickly enough, and the process would not be possible.

Camera Control

The system is designed to control an unlimited number of Pan-Tilt-Zoom (PTZ) control heads, however a normal system will control 36-72 individual PTZ heads. The control system is responsible for directing the location of a camera's view, as well as controlling individual aspects of the video camera's lens functions, such as zoom, white balance, focus, and exposure.

The data required to communicate with a given PTZ head is sent using the RS-422 (EIA-422) communication protocol, over a 4-wire physical medium such as Category 5 twisted-pair copper cable. A physical device called an “Ethernet to Serial” device converts the data from a network information packet (TCP/IP standard) directly to the RS-422 (EIA-422) specification which is delivered directly to the camera head.

In order to point a given number of video cameras to the same physical point in our 3-dimensional world, several factors must be considered. The orientation of the camera must be known, which includes the 3 dimensional location co-ordinates of the camera, and the rotation and rotational axis of the camera. This data can be determined in two ways: automatically by positioning all cameras at a target and mathematically determining the visual locations of each camera in respect to the target, or it can be surveyed using optical laser devices used in land surveying. The latter method is effective for accuracy, but must be done anytime the location of any camera may have been physically moved.

Once the location of all cameras is known, figuring out the angles at which to point the PTZ head can be calculated using trigonometry or 3-dimensional matrices. Each camera will have different pan, and tilt angles in which to point it to the given location, and this data must be determined on each camera every time it is repositioned.

The system is designed to control up to 4 PTZ heads per Server, using the same Server that digitizes the video. A master control system is responsible for determining which Server to use to control a given camera, and the data is then passed on to the required Server to perform the translation math and send out the data. This separation allows the system to be scaleable, and separates all the complicated background communication from the User Interface in which a User controls all cameras. This part of the system is called “Distributed Computing”, and designates several processes to specific hardware.

All of the cameras in the system are controlled by a single operator, who can control the system via a workstation console or a position-encoded camera control device. Using a workstation, the operator may be shown a representation of the sporting event that can be controlled with a computer mouse or joystick. Alternatively the workstation can display a video display from a single camera and the operator may use the video as a reference for controlling with a computer mouse or joystick.

If a position-encoded camera control device is used instead of a workstation, the device will take the form of a camera tripod with a display monitor attached to it, instead of a camera. It will operate like a conventional camera tripod, giving the user a display of a remote camera to view. As the tripod is moved, its telemetry data is transmitted to the processing system and will remotely control all cameras in the system.

Video Processing

The video processing system is responsible for compiling all of the video data into a useful database of information about the captured video, as well as combining the video data into a single playable video sequence based upon the video captured from a given number of cameras.

In order for the video data to be of any use, the system must catalogue information about each video that was recorded on the system. Information such as the number of frames in each video, the time at which each video frame was taken, the length of each video, the camera that recorded each video frame, and the position the camera was at when the frame was recorded. This enormous amount of information must be processed quickly, and is done so using various software processing algorithms. Once the information is catalogued, the catalogue can be passed onto the next stage of processing.

Each video the system generates is unique; it may display the video from many cameras in many ways. In order to describe how it will be displayed, a Replay Generation operator must tell the system how to display the video, or the system can automatically decide how to display the video. This process generates a detailed map of how to combine video from many sources into a single source. That map contains information such as the order in which each video is displayed, the time at which it will be displayed, and the length of the entire video to be generated. This map is a catalogue containing many other catalogues explaining how the video is to be generated.

Once the replay map is passed to the processing system, it begins to de-compress, alter (as described below), and position each video frame as described by the replay map. This process instantly generates a resulting video file that can be played on a computer, or sent to the video output system which can play the video on a television display.

During the processing of each video frame, the system may enhance the video in a number of ways. One key area of this process is “Motion Analysis”, which will attempt to generate new video frames that did not previously exist. To understand how this works, you need to know how video works. Basically, standard definition NTSC video is captured at 30 frames per second (in North America), which means every 33 ms the camera snaps a picture. Anything that happened within that first 32 ms will not be visible, which means at a given point in time, fast moving objects may not have been captured. Our Motion Analysis attempts to guess at what would have happened in the first 32 ms, to simulate a camera recording at a higher frame rate. It also attempts to simulate what the video would look like if there were a camera in-between the position of two other cameras, in order to smooth out any spinning effects in the resulting video.

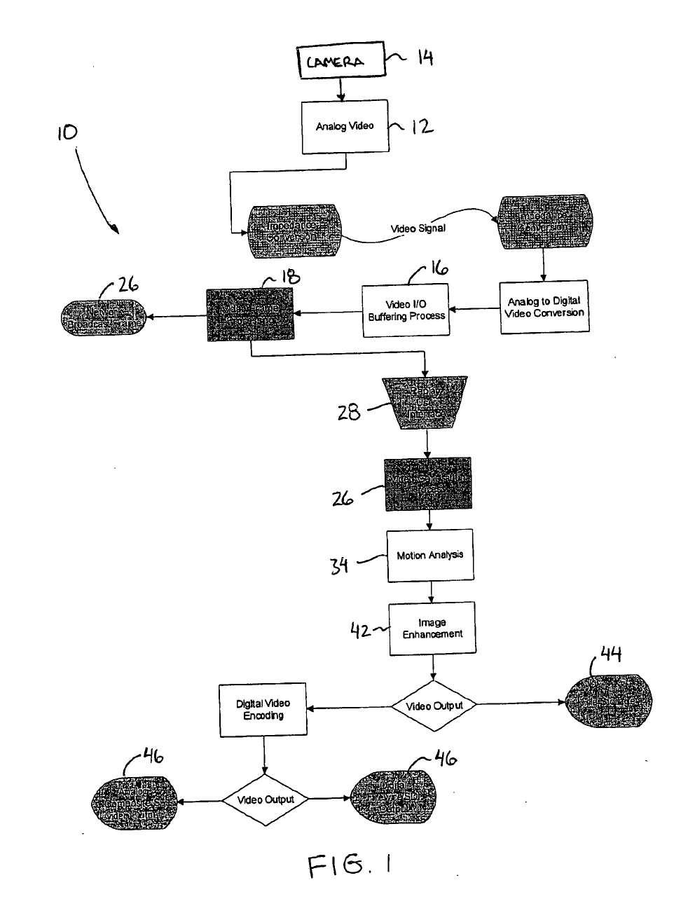

Referring more particularly now to FIG. 1, the system initially receives analog video feed 12 from each camera 14 and then suitably converts the signal initially for transmission to a server which is remote from the cameras before subsequent conversion to a digital signal. A buffer 16 receives the digital video from the converter for storing the digital video temporarily prior to mass storage on a permanent mass storage device. The digital video is stored as a plurality of video segments each comprised of a single video frame representing a static image and having segment data associated therewith.

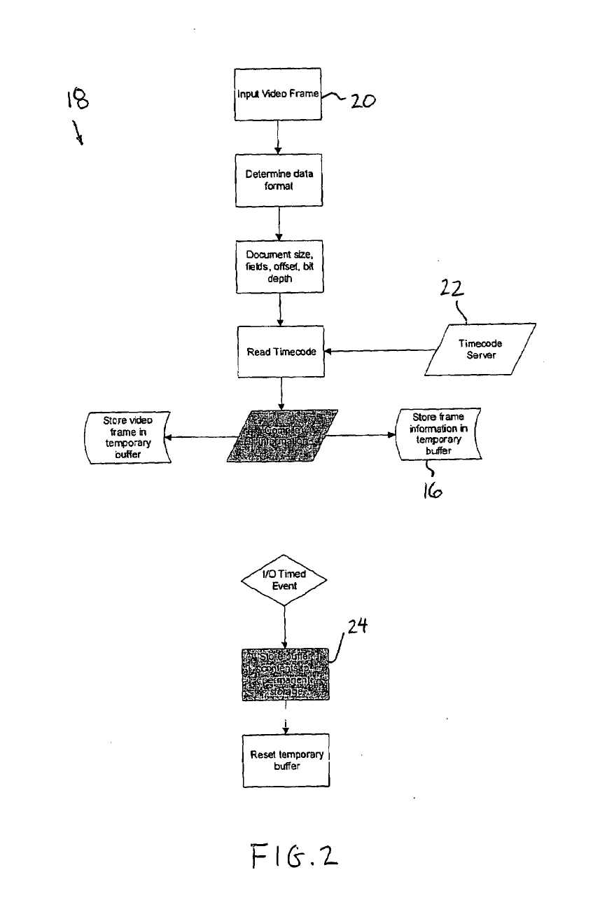

The recording of the individual video frames or segments is accomplished by a video frame processor 18 as described in further detail in FIG. 2. The processor 18 takes each input video frame 20 and associates segment data therewith by initially determining the data format along with the document size, fields associated therewith, the offset and the bit depth, etc. The associated segment data also includes a time code or time step read from a time code server 22 to associate a time step comprising an interval of time occupied by the video segment in the video feed from the cameras. The time steps of the video frames from the video feeds from all of the different cameras can thus be categorized together on the mass storage device. Compiling of the information including the video frames and the segment data associated therewith initially involves storage in the temporary buffer 16 as noted above. At periodic intervals large masses of information on the temporary buffer 16 are transferred to the permanent mass storage device with the buffer 16 being reset for accepting more data from the ongoing live video feeds of the cameras during a live event.

Referring back to FIG. 1, the stored video frame and segment data associated therewith can be instantly recalled to produce an ongoing live feed to a network broadcast 26, while at the same time selected video frames can be recalled from the mass storage device 24 to generate replay videos as desired.

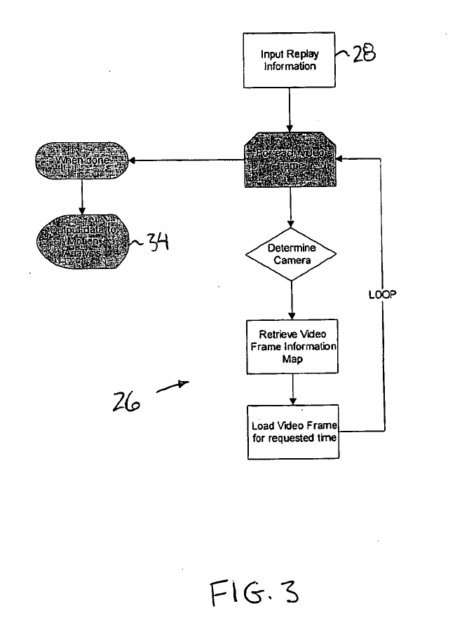

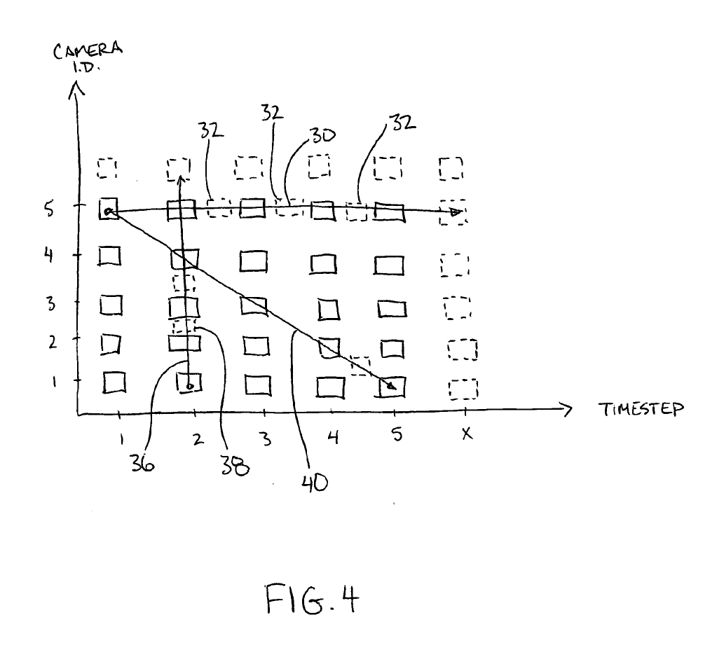

The video replay generator 26 is illustrated in further detail in FIG. 3 and generally begins with a user inputting selection criteria into the processor through a replay user interface 28 shown in further detail in FIG. 4. The replay user interface 28 comprises a graphical representation of all of the video frames categorized according to the time step at which the video frames were created and the camera location from which the respective video feed was generated. The segment data accordingly includes camera identification including camera position location data and camera orientation data. The graphical display is continuously being updated as new video frames are added to the mass storage device during the ongoing recording of a live event. The user simply selects a sequence of video frames to be assembled by the system into a resulting video by both selecting which of the video frames are to be assembled and in what order. The segment data criteria used to generate the video frame selection and assembly process will typically include which time steps are to be displayed and what sequence and at what time scale (which may be faster or slower than the input video) as well as selecting which of the cameras from the plurality of cameras the video feeds are to be selected at each time step.

The sequence of images shown by path 30 for example involve segment data criteria of advancing the time steps in sequence from a single camera feed but at a different time scale in which the intervals of time between each time step are increased to produce a slower moving replay video than the original input feed. In this instance, it may be desirable to insert auxiliary video frames 32 which are generated by a motion analysis processor 34 as described further below.

Alternatively the sequence of video frames to be selected and assembled into the resulting video may follow user selected path 36 in FIG. 4 in which a plurality of images having the same time step are recalled but in a sequence of cameras positioned at various orientations circumferentially about the target environment so that the resulting video instead comprises a rotated view about the target to be captured on video at a frozen point in time. In this instance, auxiliary frames 38 may be added where the static images produced from one camera to a next adjacent camera at a given time step differ too much from one another so as to result in an awkward or jumpy video unless an auxiliary frame of video is added in between existing frames. The auxiliary video frame represents an average of the two video frames between which the auxiliary frame 38 is inserted. The auxiliary frame 38 is also inserted by the motion analysis processor 34 referred to above and described in further detail below.

In yet a further example, a selected path 40 by the user produces a sequence of video frames in which each video frame is advanced through the sequence of cameras in relation to the previous video frame while also being advanced in time step in relation to the previous video frame so that the resulting assembled video involves a rotated point of view about the target over a changing period of time.

Using the interface 28 the user can select the segment data criteria to be used in generating the replay video, or alternatively a series of shortcut commands may be available to the operator so that the video generation processor 26 itself can select an appropriate path or sequence of video images to be selected and assembled according to a particular video effect which the user selects.

Referring to FIG. 3, the replay information is input using the interface 28 so that once a path or sequence of video frames is selected the system identifies each video frame or segment according to the selected segment data to determine which camera and at which time step the video is to be retrieved from the catalogued or categorized information on the permanent mass storage device. The selected video frames are then loaded onto the video generation processor 26 which continues in a loop to recall each individual video frame until all of the segment data criteria has been met at which point the assembled and loaded video frame information is output to the motion analysis processor 34.

The motion analysis processor serves to insert auxiliary frames 32 and 38 into the assembled video frames which form the resulting replay video for the purposes of smoothing out the appearance of the assembled videos. As noted above, two types of auxiliary frames are typically desired to be inserted. When the system varies the duration of the time steps of the output resulting replay video in relation to the input video feed to slow down the rate of display in a slow motion replay for example, in some instances, the objects between two of the original video frames of adjacent time steps differ so much from one another the resulting video would be jumpy or jerky if the time steps of each video frame were simply extended. In this instance an auxiliary frame is produced which is interpolated or averaged from the still images from two video frames of adjacent time steps from either the same camera or possibly two different cameras when generating both types of auxiliary video frames at the same time.

In the alternative instance, when simply rotating the point of view at a given time step by providing a sequence of video images from different cameras but at the same time step, the separation between the adjacent cameras may be sufficient that the static images from the two different points of view differ enough from one another to again result in a jerky or jumpy resulting video unless an intermediate auxiliary video frame is inserted in between adjacent recorded frames. This type of auxiliary frame is also generated by interpolating or averaging between two video frames, but in this instance the video frames are recalled from adjacent cameras rather than adjacent time steps.

This type of morphing generally involves manipulating two dimensional static images. When digitizing the video frames into three dimensional representations, different techniques may be employed for producing the auxiliary video frames for insertion between adjacent frames recorded on the mass storage device.

After inserting any auxiliary frames desired to smooth out the output video, an image enhancer 42 reviews the resulting video for various display characteristics, and accordingly enhances the image by ensuring optimum brightness, sharpness, and contrast to the image. The assembled and enhanced resulting replay video is then both stored on a storage device 44 and is also digitally encoded prior to being output in various formats 46 to be used as a replay video in the broadcast feed 26 to be broadcast to viewers instantly while the video feed from the cameras is continued to be recorded during the ongoing event.

In order to achieve the advantages of a replay video which is rotated about the target when a sequence of video images is assembled from adjacent cameras, it is important that the cameras are controlled in an effective manner to be simultaneously focused on a common target within the target environment about which the cameras are mounted. Typically the cameras 14 are mounted circumferentially about the target environment with each being supported to be movable in orientation at a fixed location to vary the direction of video capture of the camera in response to operational instructions.

The camera control system 50 maps out a three dimensional environment of the target environment and locates each of the cameras within that three dimensional environment. The location of all of the cameras can be accomplished by any number of known surveying techniques. In alternative embodiments however the camera locations can be identified within the target environment simply by focusing the cameras on a target object of known physical dimension so that the captured image from each camera comprises a three dimensional object mapped out by the camera control system 50. The captured image from each camera focused on the target object can thus be used to analyze the relative position of that camera to the target object by image recognition techniques as the system is able to determine what camera location would be required to capture such an image of the known target object.

For operating the system 50, a target location or target object must first be identified and input into the camera control system 50. The coordinate data of this target location to be captured within the target environment is identified within the three dimensional target environment. The system 50 is arranged to convert this coordinate data of the target location to be captured to suitable operational instructions for each of the cameras as determined by the control system 50 so that each camera would resultantly be reoriented to be directed at the target location for capturing the video image of the target location. Each time the target location is varied within the target environment, the system 50 must again use the coordinate data of all of the cameras and the target object within the target environment to calculate how each camera must be redirected so as to produce suitable operational instructions for each camera which will then redirect the camera to follow a moving target object or target location.

Various methods may be used to determine what the input target location is. In some embodiments, the control system 50 may input the target location automatically by tracking a player within a sporting event or by tracking the playing object, for example a puck or ball manipulated by the players in a sport. Tracking of the player or object may be accomplished by tagging the player by visual means or by a generated signal from a transmitter carried by the object so that the control system 50 can locate the object within the three dimensional target environment and identify its coordinates to be input into the operational instruction generator 52 of the control system 50.

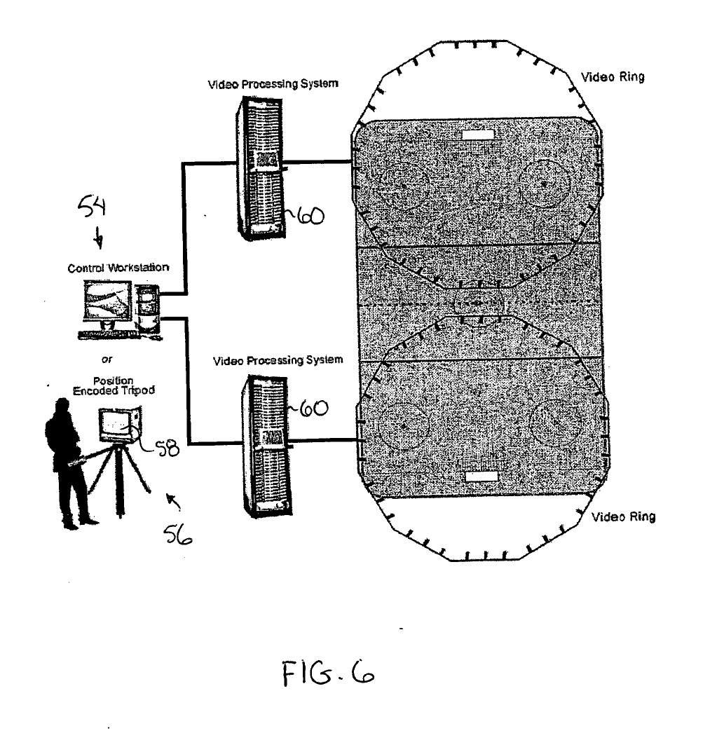

Alternatively the coordinate data of the target location can be input manually by a user using a suitable interface 54 as shown schematically in FIG. 6 for example. The control user interface 54 may comprise a computer work station, or alternatively may comprise a control device 56 as shown in FIG. 6 of the type including a movable display 58. In this instance the control device 56 is associated with a master camera having a video feed which defines the target location wherein the movable display 58 displays the video feed from the master camera. In this instance, reorienting the movable display 58 causes a position encoding device to transmit appropriate operational instructions to the master camera to displace the master camera in a corresponding manner to movement of the display 58. The control system 50 in this instance uses the video feed from the master camera and automatically identifies the target location within the three dimensional target environment which the master camera is directed at and uses this coordinate data of the defined target location as the input to the operational instruction generators 52 of the cameras so that all of the other cameras follow whatever the master camera is directed at.

The camera control system 40 generally involves a distributed computing model involving a hierarchy of servers in which a master server 60 executes a communication server assignment process to determine which cameras should be reoriented and to determine which of a plurality of communications servers 62 are associated with the cameras to be reoriented. Each communication server 62 is designated a respective set of cameras 14 for controlling all operations associated with those cameras. Each of the plurality of servers 62 thus includes its own operational instructions generator 52 for determining the operational instructions required for each of the cameras associated with that server which are required to maintain the cameras focused on the target location as the target location is displaced about the target environment.

The recording of video frames from the video feeds of each of the cameras is also commonly accomplished by the communication servers 62 so that each camera feeds its video signal to the server 62 associated therewith. Each server 62 thus goes through the process of suitably converting the video signals from the cameras associated therewith to process the associated therewith to process the individual video frames thereof and catalogue the video segments of the video feeds according to the respective segment data associated therewith on a mass storage device associated with that server 62.

Communication between each camera and its respective server 62 is thus two way in that operational instructions are transmitted from the generator 52 to the server 62 to each camera 14 to reorient the cameras to the target object while at the same time video feed is continuously transmitted back to the server 62 for suitable storage as individual digitized video frames categorized according to segment data associated therewith.

The video generating system 10 also includes a systems monitor 70 which executes various functions to ensure that system failures are recognized and overcome as efficiently as possible to automatically deal with the failures and permit the system to be used reliably during a live sporting event in which the replays are generated virtually instantaneously. The systems monitor 70 for instance can identify a camera failure 72, an environment failure 74, a communications failure 76, a server failure 78, or a service failure 80. In the event of a camera failure for instance, the failed camera can be deactivated if attempts to reset it are not successful. Once the camera is deactivated, the system 10 is able to recognize that video frames are no longer being stored and categorized from that particular camera and thus when replay videos are selected which may involve a video frame from that camera, appropriate measures can be taken by the system to automatically generate the appropriate auxiliary frames required to compensate for the missing camera video feed.

In the event of a communications failure for example, the appropriate communications can be deactivated and a backup communication device can instead be powered on and automatically configured to replace the deactivated device.

Similarly in the event of a server failure, the appropriate server 62 can be deactivated and the cameras 14 associated therewith can either be deactivated or rerouted to a different back up server which will then assume all of the functions required of the previously failed server when the back up server is activated. In general, the systems monitor periodically checks the operation of all cameras so that when a camera is failing, both the generation of operational instructions for that camera and the recording of video segments from that camera can be discontinued.

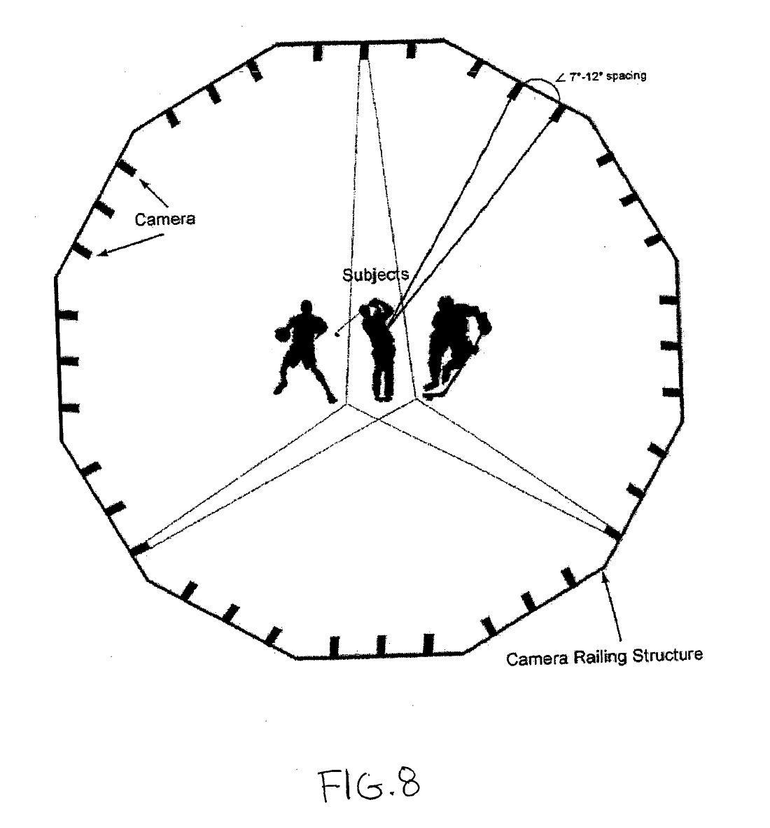

FIG. 8 illustrates a common positioning of the cameras for most sporting events in which the cameras are positioned generally circumferentially about the target environment with the direction of video capture of the cameras being generally directed inwardly toward a common target object within the target environment. The orientation of the cameras and the zoom function thereof will continuously vary as the target object moves within the target environment, however the camera location within the target environment generally remains fixed.

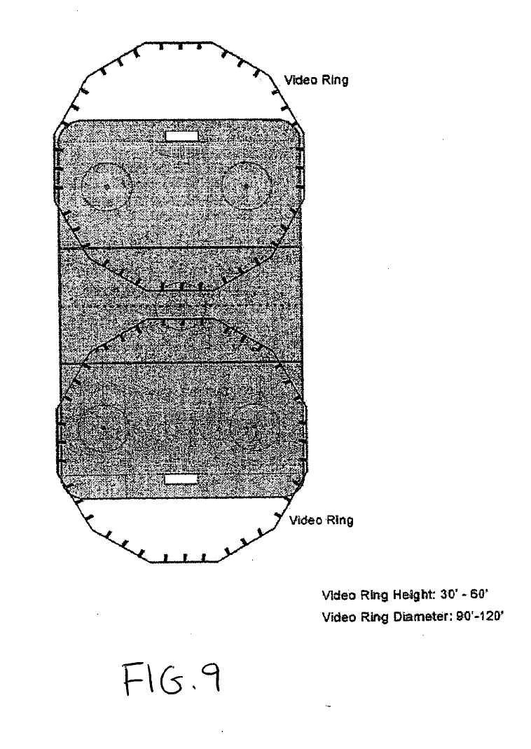

As shown in FIG. 9, in sports involving goals at opposing ends of the playing surface such as a hockey rink, it maybe desirable to provide two parallel systems in which the cameras 14 of each system are positioned generally circumferentially about the goal at a respective end of the playing surface. In this configuration, each of the sets of circumferentially positioned cameras 14 communicates with its own master server 60 receiving instructions from a common control input or control user interface 54 as shown in FIG. 6.

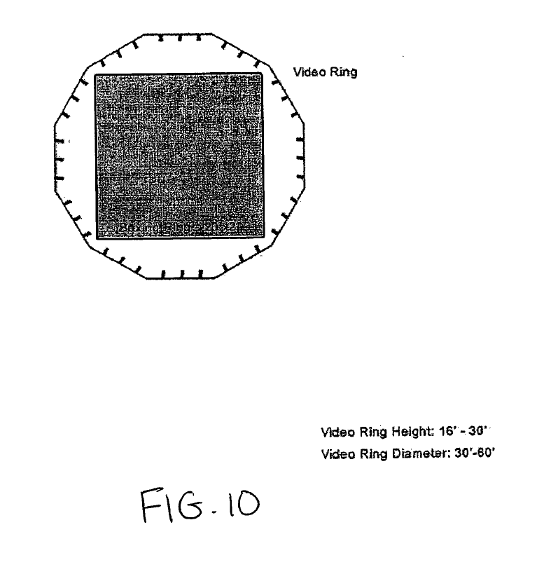

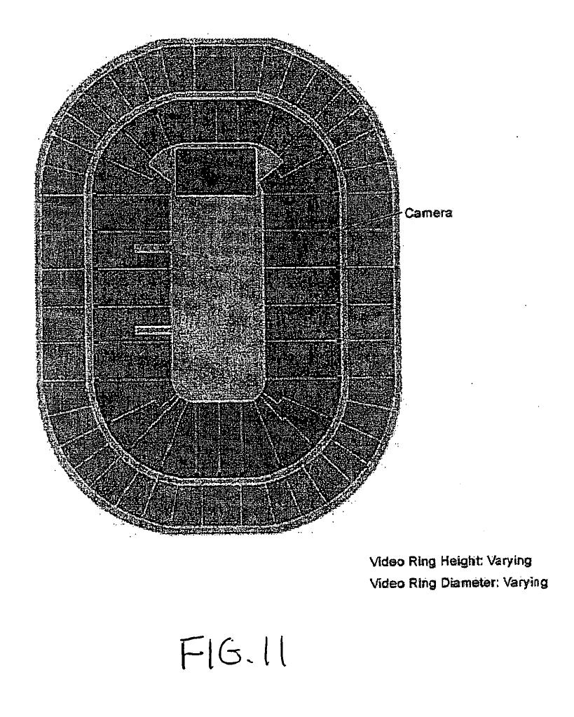

In a sporting event such as boxing for example in which the sporting action is generally contained within a designated area, all of the cameras 14 may be positioned in a single circumferential pattern about the target environment. In the embodiments of FIGS. 8 through 10 the cameras are generally supported on an auxiliary frame structure supported above the target environment. As shown in FIG. 11 however, the cameras may instead be mounted on portions of the building itself housing the target environment such as various frame members or poles supported within a stadium or arena. In each instance, the cameras are preferably supported at a common height above the target environment, however the system can still function effectively with some variation in the height between adjacent cameras.

Since various modifications can be made in my invention as herein above described, and many apparently widely different embodiments of same made within the spirit and scope of the claims without department from such spirit and scope, it is intended that all matter contained in the accompanying specification shall be interpreted as illustrative only and not in a limiting sense.

1. A method of producing a resulting video of an event in a target environment, the method comprising:
providing a plurality of cameras directed at a common target in the target environment;
generating a video feed from each camera comprising a sequence of video segments over time, in which each video segment comprises a static image in the sequence at a respective point in time;
associating segment data with each video segment, said segment data including time step data representing the point in time when the video segment was generated and camera identification data representing the camera from which the video segment is generated;
recording the video segments and the associated segment data onto a storage device;
categorizing the video segments on the storage device according to the associated segment data;
selecting a selected sequence of the video segments to be used in the resulting video to be generated;
recalling the selected sequence of the video segments from the storage device by identifying the segment data associated therewith; and
assembling the selected sequence of the video segments into the resulting video.

2. The method according to claim 1 including recording and categorizing the video segments in a realtime, instantaneous manner.

3. The method according to claim 1 including assembling the selected sequence into the resulting video instantaneously upon recordation of the video segments of the selected sequence.

4. (canceled)

5. The method according to claim 1 wherein at least one pair of adjacent ones of the video segments of the selected sequence forming the resulting video comprises video segments which are generated from adjacent ones of the cameras.

6. The method according to claim 1 wherein at least one pair of adjacent ones of the video segments of the selected sequence forming the resulting video comprises video segments which are generated at a common point in time.

7. The method according to claim 1 wherein the camera identification data includes camera position data and camera orientation data.

8. (canceled)

9. (canceled)

10. (canceled)

11. (canceled)

12. (canceled)

13. The method according to claim 1 including selecting and assembling video segments according to segment data criteria and providing a user interface comprising a graphical representation of the video segments categorized according to both time step data and camera identification data selecting the segment data criteria graphically using the user interface.

14. The method according to claim 1 including selecting and assembling video segments according to segment data criteria, wherein the segment data criteria is automatically determined by an automated controller.

15. (canceled)

16. (canceled)

17. (canceled)

18. The method according to claim 1 including redirecting the cameras to follow a moving target in the target environment.

19. (canceled)

20. The method according to claim 1 including orienting each camera relative to adjacent ones of the cameras such that each video segment generated by each camera generally approximates an image interpolated between video segments generated by the adjacent ones of the cameras at the same point in time.

21. The method according to claim 1 including identifying a location of each camera in relation to the target environment; identifying location of the target in relation to the target environment; calculating the operational instructions for each camera using the location of the camera and the location of the target relative to the target environment such that the operational instructions are arranged to orient the direction of video capture of the camera towards the target; orienting each camera to capture video of the target using the operational instructions; and recalculating the operational instructions for each camera each time the location of the target relative to the target environment changes to follow the target as the target is displaced within the target environment.

22. The method according to claim 21 including identifying the location of each camera by focusing the cameras on a three dimensional target object and analyzing a two dimensional image captured by each camera to determine the relative position of the camera to the three dimensional target object.

23. The method according to claim 22 including varying the location of the target using a control device comprising a user controllable master camera having a video feed which defines the location of the target and calculating the operational instructions for the plurality of cameras such that the plurality of cameras follow the location of the target defined by the master camera.

24. The method according to claim 23 wherein the control device includes a controller comprising a movable display arranged for displaying the video feed from the master camera and a position encoding device arranged for displacing the master camera responsive to corresponding displacement of the moveable display.

25. The method according to claim 21 including providing a plurality of servers, each arranged to convert the location of the target to the operational instructions for a plurality of the cameras.

26. (canceled)

27. The method according to claim 1 including interpolating between an adjacent pair of the video segments in the selected sequence to produce an auxiliary video segment and assembling the selected sequence of the video segments and the auxiliary video segment together into the resulting video.

28. (canceled)

29. (canceled)

30. (canceled)

31. (canceled)

32. (canceled)

33. (canceled)

34. (canceled)

35. The method according to claim 1 wherein the plurality of cameras supported circumferentially about the target environment.

36. (canceled)

37. (canceled)

38. (canceled)

39. A method of controlling a plurality of cameras to capture a target within a target environment, the method comprising:
positioning the plurality of cameras within the target environment;
arranging each camera to be movable in orientation to vary a direction of video capture of the camera in response to operational instructions;
identifying a location of each camera in relation to the target environment;
identifying location of the target in relation to the target environment;
calculating the operational instructions for each camera using the location of the camera and the location of the target relative to the target environment such that the operational instructions are arranged to orient the direction of video capture of the camera towards the target;
orienting each camera to capture video of the target using the operational instructions; and
recalculating the operational instructions for each camera each time the location of the target relative to the target environment changes to follow the target as the target is displaced within the target environment.

40. (canceled)

41. The method according to claim 39 including orienting each camera relative to adjacent ones of the cameras such that each video segment generated by each camera generally approximates an image interpolated between video segments generated by the adjacent ones of the cameras at the same point in time.

42. (canceled)

43. (canceled)

44. (canceled)

45. (canceled)

46. (canceled)

47. A method of producing a resulting video of an event in a target environment, the method comprising:
providing a plurality of cameras directed at a common target in the target environment;
generating a video feed from each camera comprising a sequence of video segments over time, in which each video segment comprises a static image in the sequence at a respective point in time;
recording the video segments onto a storage device;
selecting a selected sequence of the video segments to be used in the resulting video to be produced;
interpolating between an adjacent pair of video segments in the selected sequence to produce an auxiliary video segment; and
assembling the selected sequence of the video segments and the auxiliary video segment into the resulting video.

48. (canceled)

49. (canceled)
